(19) United States
(12) Patent Application Publication
(10) Pub. No.: US 2013/0162536 A1
(43) Pub. Date: Jun. 27, 2013

(54) SYSTEMS AND METHODS FOR ENABLING OR ACCESSING OR VIEWING COMPONENTS, INVOLVING AN INPUT ASSEMBLY AND A SCREEN

(71) Applicant: Vaibhav Narayan Khedkar, Raigad (IN)

(72) Inventor: Vaibhav Narayan Khedkar, Raigad (IN)

(21) Appl. No.: 13/705,204

(22) Filed: Dec. 5, 2012

(30) Foreign Application Priority Data
Dec. 5, 2011 (IN) 3423/MUM/2012

(51) Int. Cl. G06F 3/0354

(52) U.S. Cl. CPC G06F 3/0354
USPC 345/158

(57) ABSTRACT

The present invention in a preferred embodiment provides systems and methods for enabling or accessing or viewing components through a graphical user interface, wherein the system comprises,
a) an input assembly;
b) a screen unit; and
c) an electronic device;
wherein the said input assembly comprises,
   i. a sensory component;
   ii. a data processing unit; and
   iii. a selection component; and
wherein the said screen unit is connected to the said electronic device; and
wherein the said input assembly is capable of throwing an outgoing signal towards the said screen unit in a manner to direct the said outgoing signal on the said screen unit using the said selection component; and
wherein on receiving the said outgoing signal, the said screen unit sends a secondary outgoing signal to the said electronic device; and
wherein the said electronic device processes the said secondary outgoing signal and transfers a final outgoing signal to a graphical user interface enabled by the electronic device to generate a output.

### BACKGROUND OF THE INVENTION

Conventionally used input systems for an electronic device include keyboard, mouse, touch-screen, touch-pad, etc. However, most of these input systems may only be operated from a short distance which may result to be uncomfortable or harmful to human eyes due to continuous use and thus may not be user friendly. More than one computer may not be easily operated by single person because of the limited input systems.

Now a days, mobile telephones, personal digital assistants, and similar hand-held mobile electronic devices offer additional functions such as the capability to play video games along with desktop or laptop computers. The games for such devices have tended to become more complex, with more realistic graphics, more complicated game play, and other improvements. Concurrently, the devices themselves have become more sophisticated. Moreover, three dimensional effects have added more enjoyment and thrill to the games. Development of such games is complex and requires graphic artists and highly skilled programmers and compatible systems or devices. Such compatible devices are costly to manufacture and requires lot of maintenance.

Hence, there is a requirement for a system which shall allow a user to easily access, control, or provide input remotely to one or more electronic devices and at the same time not use elaborate wiring. The present invention provides alternative to similar systems and methods in the art and also may be cost effective and efficient. In its various embodiments, present invention also addresses the above mentioned and other possible drawbacks and limitations of the currently used systems and methods relating to the field of systems and methods for enabling or accessing or viewing components, involving an input assembly and a screen.

### FIELD OF THE INVENTION

The present invention relates to the field of systems and methods for enabling or accessing or viewing components.

### SUMMARY OF THE INVENTION

The present invention in a preferred embodiment provides systems and methods for enabling or accessing or viewing components through a graphical user interface, wherein the system comprises,
a) an input assembly;
b) a screen unit; and
c) an electronic device;
wherein the said input assembly comprises,
   i. a sensory component;
   ii. a data processing unit; and
   iii. a selection component;
wherein the said screen unit is connected to the said electronic device; and
wherein the said input assembly is capable of throwing an outgoing signal towards the said screen unit in a manner to direct the said outgoing signal on the said screen unit using the said selection component; and
wherein on receiving the said outgoing signal, the said screen unit sends a secondary outgoing signal to the said electronic device; and
wherein the said electronic device processes the said secondary outgoing signal and transfers a final outgoing signal to a graphical user interface enabled by the electronic device to generate a output.

### BRIEF DESCRIPTION OF DIAGRAMS

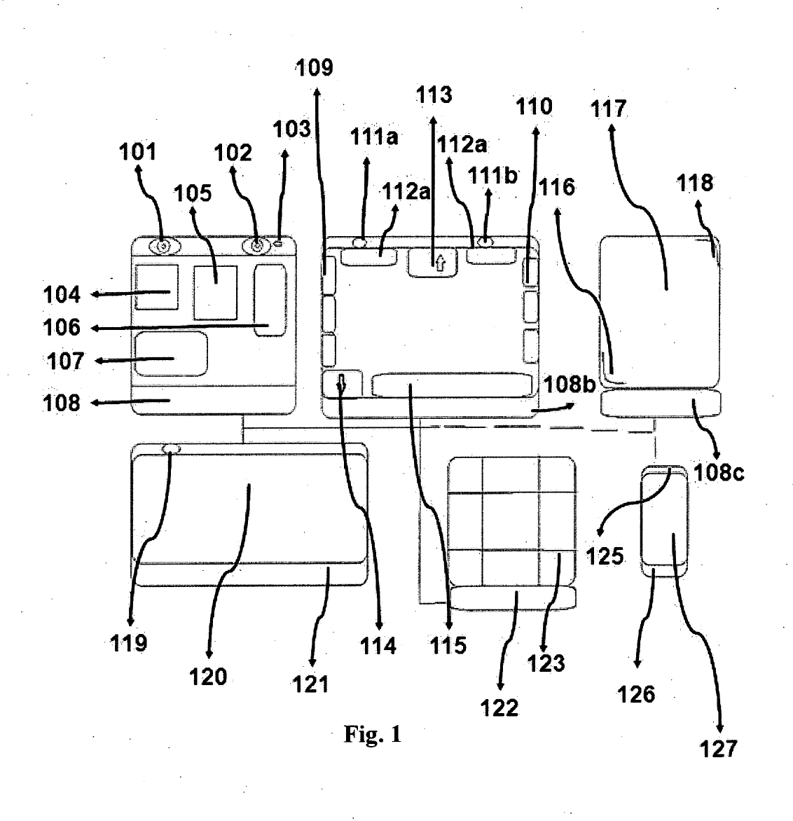

FIG. 1 is the diagrammatic representation of an example of one of the embodiments of the invention, wherein different screen units are shown.

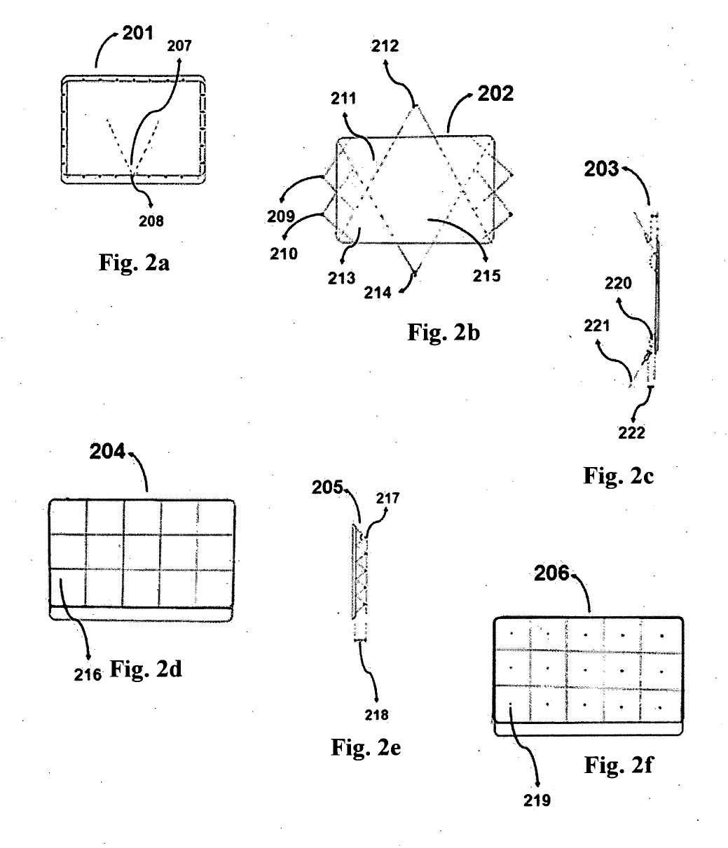

FIG. 2a, FIG. 2b, FIG. 2c, FIG. 2d, FIG. 2e and FIG. 2f are the diagrammatic representations of an example of one of the embodiments of the invention, wherein different projectors are shown.

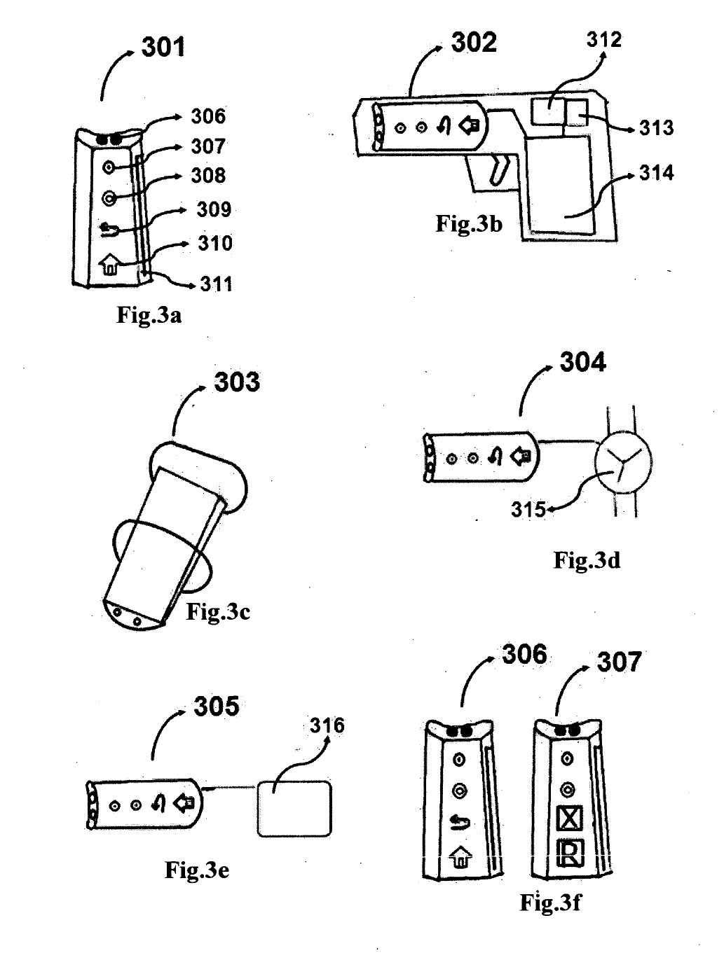

FIG. 3a, FIG. 3b, FIG. 3c, FIG. 3d, FIG. 3e, and FIG. 3f are the diagrammatic representations of an example of one of the embodiments of the invention, wherein different input devices which may be connected to an input assembly are shown.

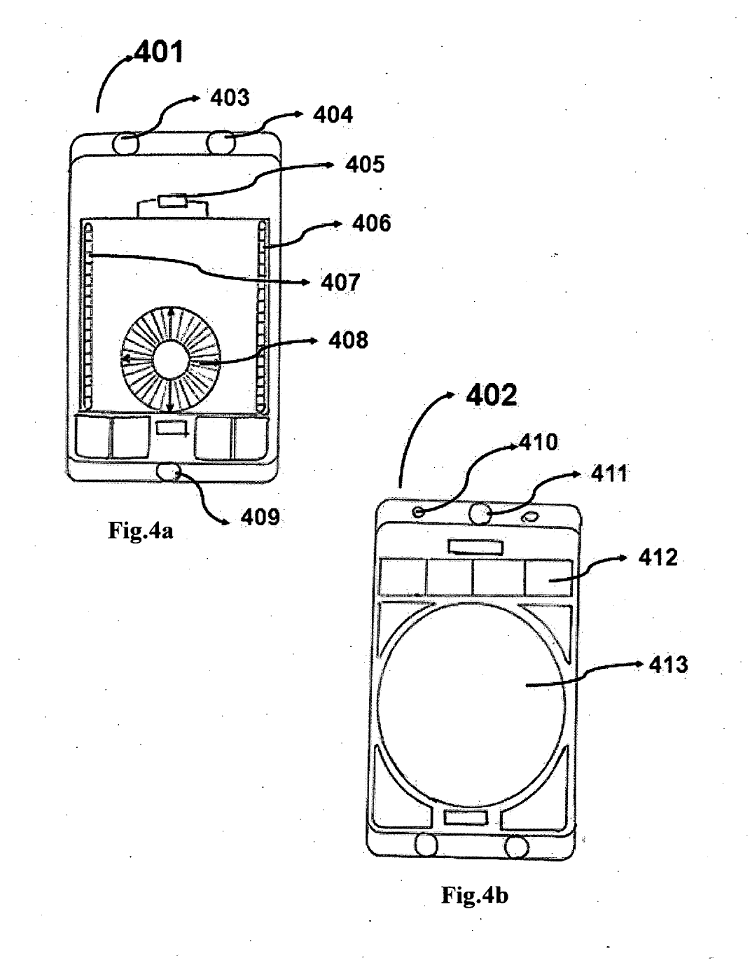

FIG. 4a and FIG. 4b are the diagrammatic representations of an example of one of the embodiments of the invention, wherein 3D locator and its components are shown.

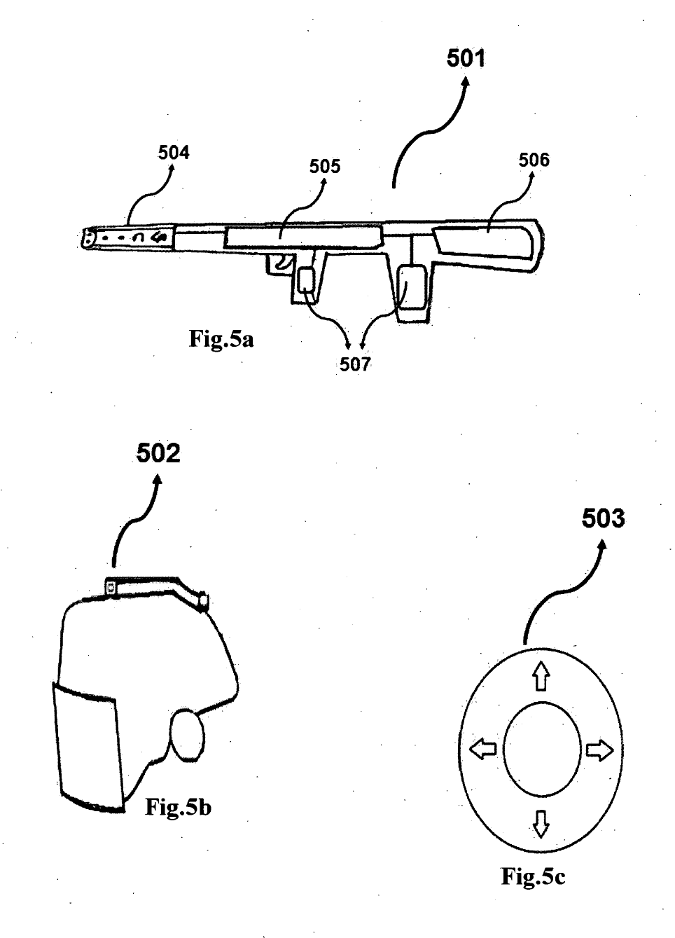

FIG. 5a, FIG. 5b and FIG. 5c are the diagrammatic representations of an example of one of the embodiments of the invention, wherein different input devices used for gaming purpose, which may be connected to an input assembly are shown.

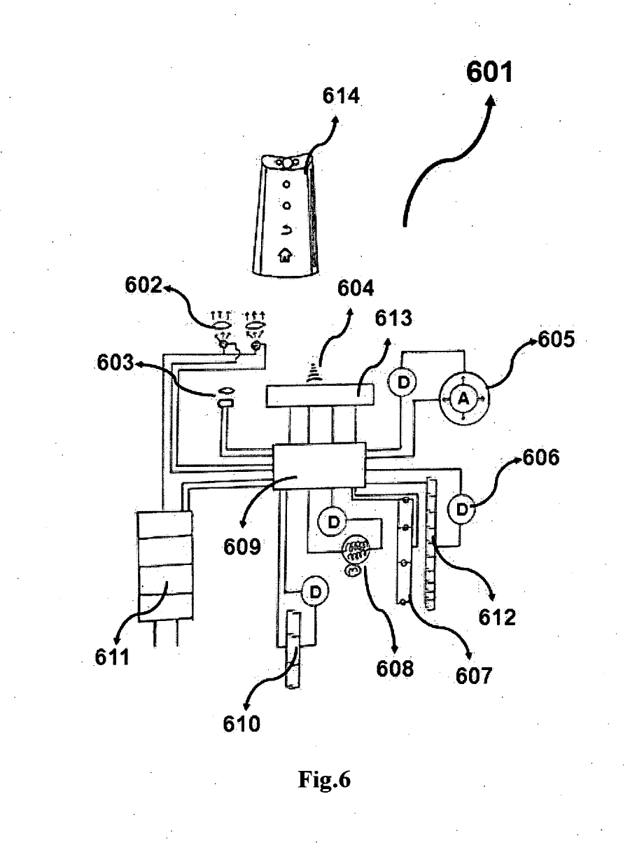

FIG. 6 is the diagrammatic representation of an example of one of the embodiments of the invention, wherein a working of an input device which may be connected input assembly is shown.

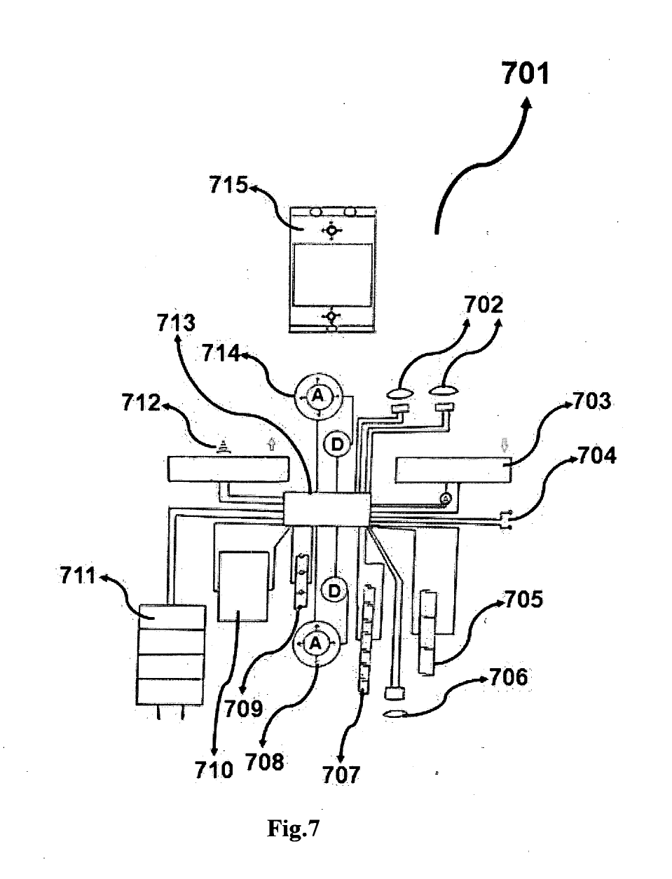

FIG. 7 is the diagrammatic representation of an example of one of the embodiments of the invention, wherein a working of a 3D locator which may be connected input assembly is shown.

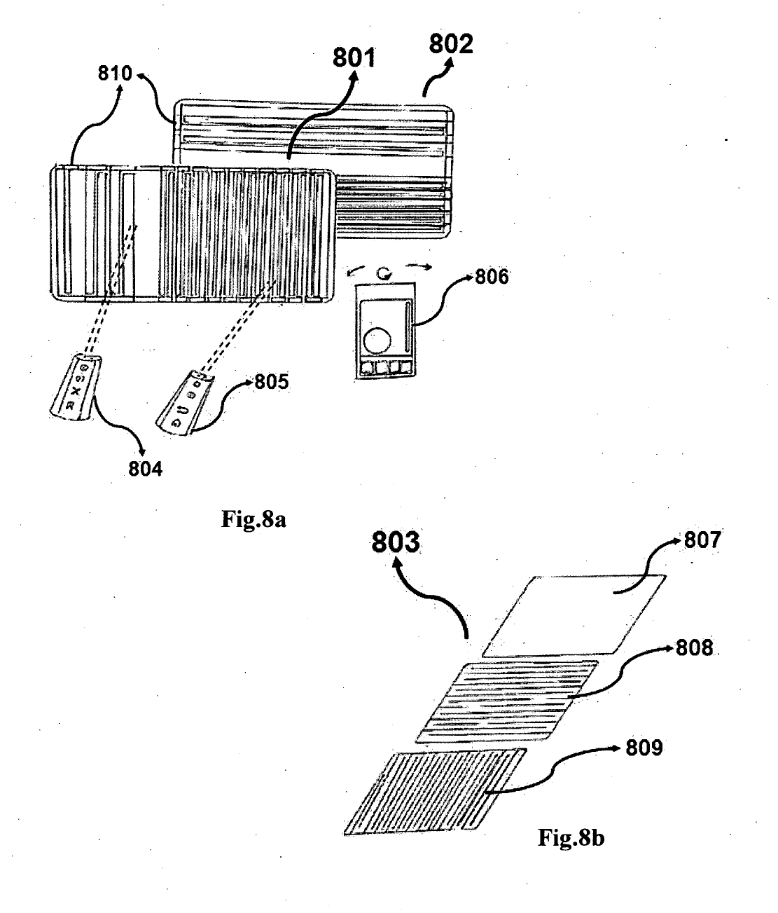

FIG. 8a and FIG. 8b are the diagrammatic representation s of an example of one of the embodiments of the invention, wherein the working of wearable multipointer device and 3d locator device is shown.

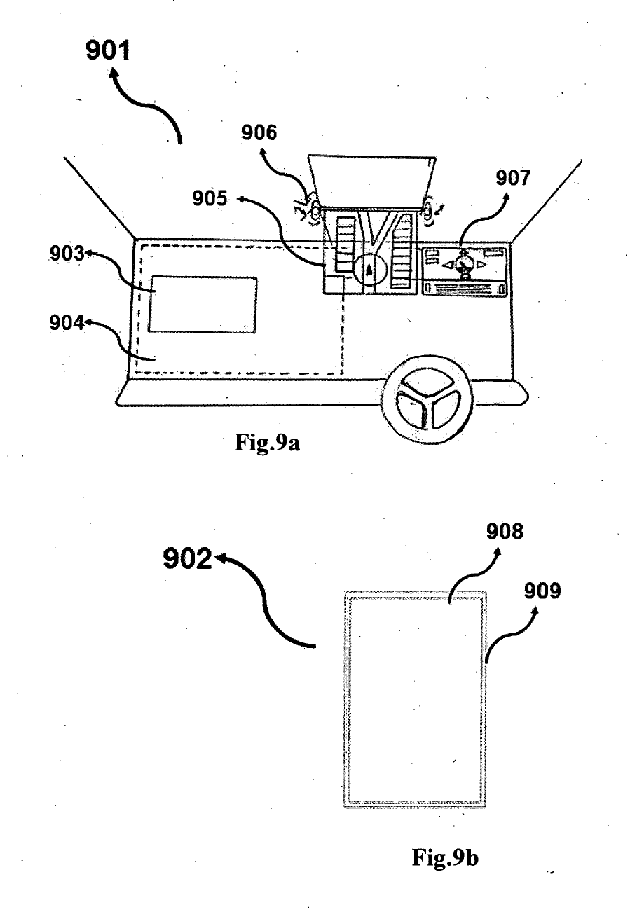

FIG. 9a and FIG. 9b are the diagrammatic representations of an example of one of the embodiments of the invention, wherein applications of the disclosed system is shown.

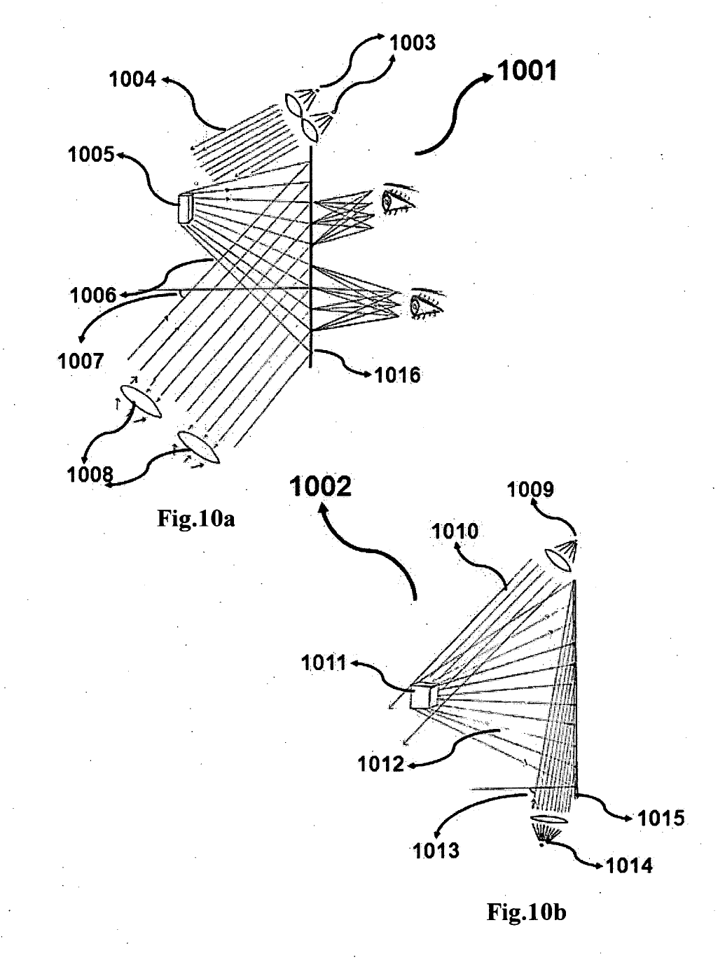

FIG. 10a and FIG. 10b are the diagrammatic representations of an example of one of the embodiments of the invention, wherein “total interference pattern recording and viewing” is shown.

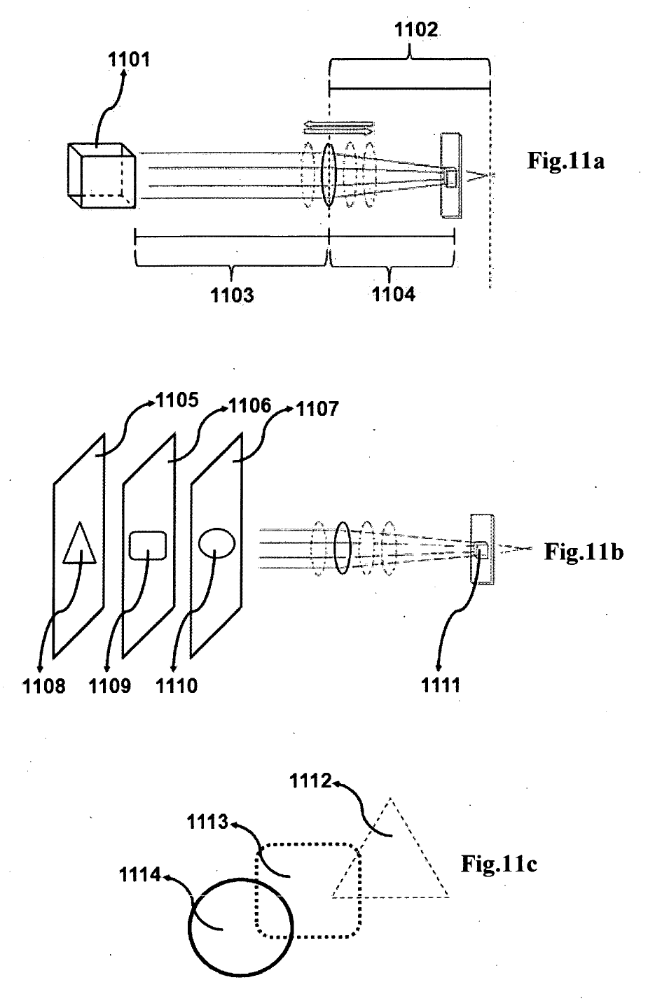

FIG. 11a, FIG. 11b and FIG. 11c are the diagrammatic representations of an example of one of the embodiments of the invention, wherein an example of “total interference pattern recording and viewing” is shown.

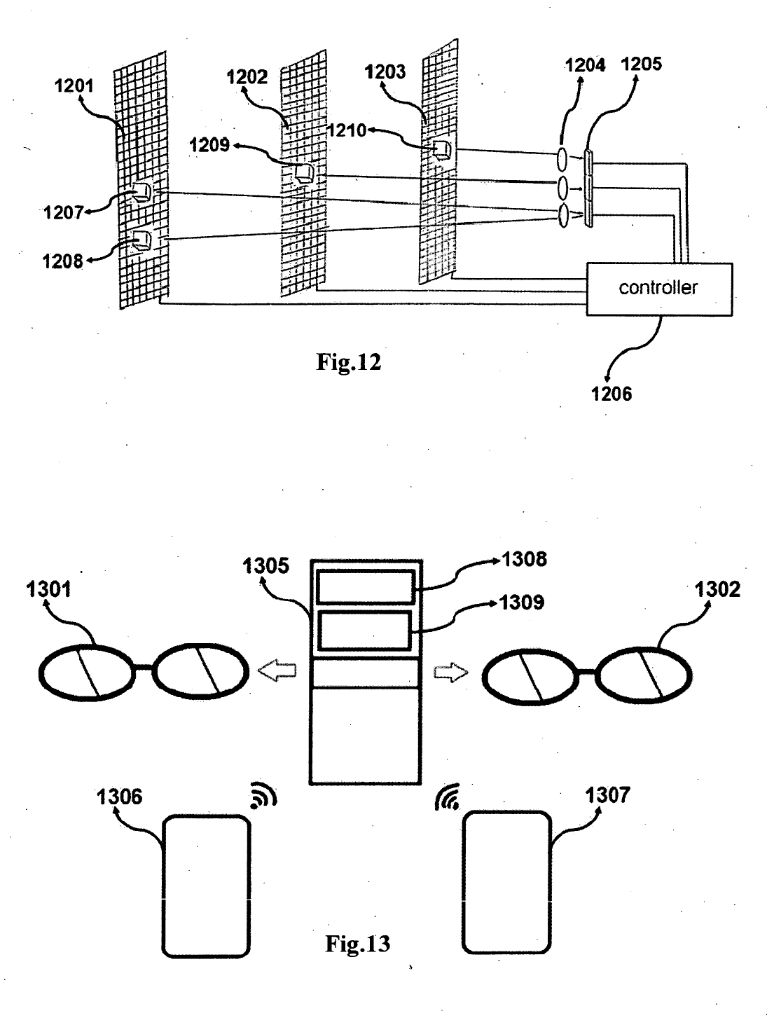

FIG. 12 is the diagrammatic representation of an example of one of the embodiments of the invention, wherein digital recording cameras for 3D recording are shown.

FIG. 13 is the diagrammatic representation of an example of one of the embodiments of the invention, wherein one of applications of the system disclosed herein is shown.

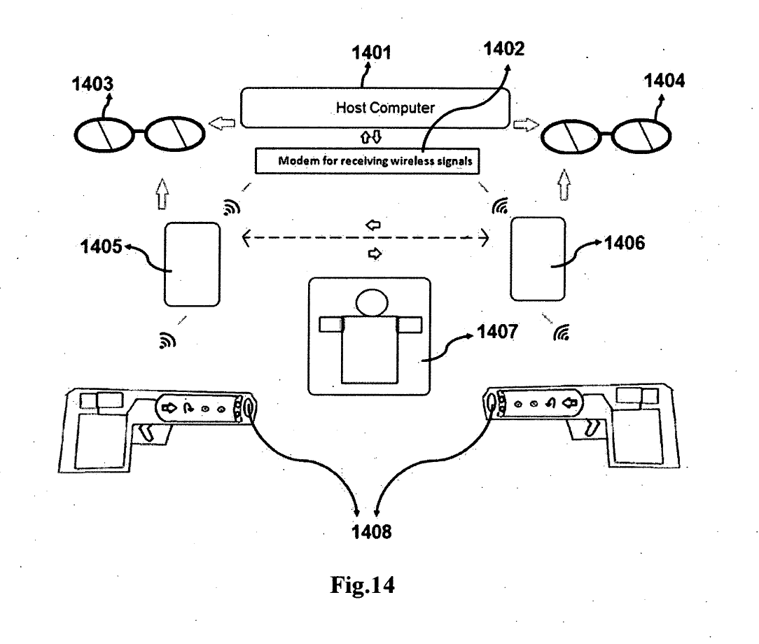

FIG. 14 is the diagrammatic representation of an example of one of the embodiments of the invention, wherein one of applications of the system disclosed herein is shown.

### DETAIL DESCRIPTION OF THE INVENTION

The present invention in a preferred embodiment provides systems and methods for enabling or accessing or viewing components through a graphical user interface, wherein the comprises,
a) an input assembly;
b) a screen unit; and
c) an electronic device;
wherein the said input assembly comprises,
   i. a sensory component;
   ii. a data processing unit; and
   iii. a selection component;
wherein the said screen-unit is connected to the said electronic device; and
wherein the said input assembly is capable of throwing an outgoing signal towards the said screen unit in a manner to direct the said outgoing signal on the said screen unit using the said selection component; and
wherein on receiving the said outgoing signal, the said screen unit sends a secondary outgoing signal to the said electronic device; and
wherein the said electronic device processes the said secondary outgoing signal and transfers a final outgoing signal to a graphical user interface enabled by the electronic device to generate a output.

The sensory component receives an incoming signal based on a user input and the processing unit converts this incoming signal to an outgoing signal which is directed towards the screen unit through a selection component, wherein the outgoing signal is emitted and directed by the selection component on the screen. The selection component enables the input assembly to select a region on the screen unit which shall receive the outgoing signal, and then the selection component emits and directs the outgoing signal on the selected region on the screen unit.

Thus, the input assembly overall uses a sensory component to receive incoming signals, processes the signal through the processing unit and emits outgoing signal through the selection component, the outgoing signal being received by is received by the screen unit.

In an embodiment of the invention, a screen unit is capable of acting as an input assembly.

In an embodiment of the invention, the screen unit comprises a grid formed with by films, wherein the films intersect each other at different points and one or more of the film is connected to a photo detector or sensor.

In an embodiment of the invention, the films may be transparent, or semi-transparent, or translucent, or semi-translucent or opaque, or any combination thereof.

In an embodiment of the invention, the films may be are non-conductors, conductor, or semi-conductor or heat and electricity, or any combination thereof.

In an embodiment of the invention, the signal emitted by the input assembly is received by the film which is detected by the photo detector or sensor connected to one or more of the film.

In an embodiment of the invention, the sensory component may include but is not limited to an accelerometer, or a speech recognition system, or a touch sensitive system, or an orientation sensor, or any combination thereof.

The sensory component for the purpose of this invention may sense movement of the input assembly, whenever a switch is activated or deactivated, voice commands, touch or scroll movements on touchpad, or a touch screen, or any combination thereof.

In an embodiment of the invention, the screen unit of the present invention may be mounted on an object such as but not limited to wall, board, projecting screen, movie screen, screen or monitor of an electronic device, window glass, roof, vehicle windshield, or any combination thereof.

In an embodiment of the invention, the screen unit of the present invention may be mounted at a distance, or an angle, or may have any size or shape, or any combination thereof.

In an embodiment of the invention, the input assembly may comprise a remote sensory component having appropriate size to screen unit which may be used for direct human interaction with the system, such as through human gestures, or signs or motion or signal, or particular activity, or any combination thereof.

In an embodiment of the invention, the input assembly may allow a user perform various functions such as accessing data stored in an electronic device, to select one or more virtual object, to highlight or select one or more part visible on the screen, or any combination thereof.

The term ‘virtual object’ for the purpose of this invention may include but is not limited to any text, photo, video, audio or any file which is present in an electronic device.

In an embodiment of the invention, the input assembly may further comprise of touch pad for scrolling, a switch to access particular component of an electronic device, a touch screen to access a particular component of an electronic device or scroll, or any combination thereof.

In an embodiment of the invention, the screen unit of the systems of the invention may be mounted on a plane object such as a wall, wherein the visible components on the screen or monitor of an electronic device may be projected on the said screen unit of the present invention which remains mounted on the plane object such as a wall.

In an embodiment of the invention, method for enabling or accessing or viewing components comprises the steps of,
a) sensing of a user input by a sensory component in the form of an input signal;
b) processing of the input signal by a data processing unit into an outgoing signal;
c) transforming the voice, or touch, or gesture, or movement into the input signal;
d) using a selection component to emit and direct the outgoing signal on the selected region on the screen unit;
e) receiving the outgoing signal emitted from the input assembly by the screen unit;
f) using an electronic device data processing unit of an electronic device connected to the screen unit to the process the said outgoing signal; and
g) using a final outgoing signal generated by the electronic device data processing unit to provide a graphical user interface output through a graphical user interface enabled by the electronic device.

In an embodiment of the invention, a method for enabling or accessing or viewing components through a graphical user interface comprises steps of,
a) sensing of a user input by a sensory component in the form of an input signal;
b) processing of the input signal by a data processing unit into an outgoing signal;
c) transforming the voice, or touch, or gesture, or movement into the input signal;
d) using a selection component to emit and direct the outgoing signal on the selected region on the screen unit;
e) receiving the outgoing signal emitted from the input assembly by the screen unit;
f) transferring a secondary outgoing signal by the screen unit to an electronic device;
g) using a data processing unit of the electronic device connected to the screen unit to the process the said secondary outgoing signal; and
h) using a final outgoing signal generated by the electronic device data processing unit to provide a graphical user interface output through a graphical user interface enabled by the electronic device.

In an embodiment of the invention, a sensory component, wherein the sensory component may include but is not limited to an accelerometer, or a speech recognition system, or a touch sensitive system;

In an embodiment of the invention, a user based input may be selected from but not limited to voice, touch, gesture, movement or any combination thereof.

In an embodiment of the invention, the screen unit may be of various types such as but not limited to liquid crystal display (LCD), or light emitting diode (LED), resistive, Surface acoustic wave (SAW), capacitive screen coated with a transparent conductor such as indium tin oxide (ITO), Projected Capacitive Touch (PCT), mutual capacitive sensors, Self-capacitance sensors, Optical imaging, Dispersive signal technology, Acoustic pulse recognition, or any combination thereof.

In one aspect of the invention, incident light passed through a lens unit may be induced on a screen unit or on an object kept at a distance. The light rays emitted from the object may be recorded by a processing unit which may be connected to the screen unit. An image of the said object may be formed by the processing unit on the said screen unit.

In an embodiment of the invention, the system further comprises of,
a) a three dimensional optical unit; and
b) a projector unit;
   wherein the three dimensional optical unit is connected to a screen and the projector unit is connected to an electronic device; and
   wherein the three dimensional optical unit comprises,
i. at least one detector; and
ii. at least one optical tracking unit; and
   wherein the at least one optical tracking unit is connected to the at least one detector unit; and
   wherein the optical tracking unit comprises at least one motor and a set of lenses; and
   wherein the motor enables a movement of the lenses.

In an embodiment of the invention the system further comprises,
a) an input assembly;
b) a screen unit; and
c) an electronic device;
d) a three dimensional optical unit and
e) a projector unit;

wherein the said input assembly comprises,
i. a sensory component;
ii. a data processing unit; and
iii. a selection component; and

wherein the said screen unit is connected to the said electronic device; and

wherein the said input assembly is capable of throwing an outgoing signal towards the said screen unit in a manner to direct the said outgoing signal on the said screen unit using the said selection component; and

wherein on receiving the said outgoing signal, the said screen unit sends a secondary outgoing signal to the said electronic device; and

wherein the said electronic device processes the said secondary outgoing signal and transfers a final outgoing signal to a graphical user interface enabled by the electronic device to generate a output; and

wherein the three dimensional optical unit is connected to the said screen and the said projector unit is connected to the said electronic device; and

wherein the said three dimensional optical unit comprises,
A. at least one detector and
B. at least one optical tracking unit; and

wherein the said at least one optical tracking unit is connected to the at least one detector unit;

and wherein the said optical tracking unit comprises at least one motor and a set of lenses; and

wherein the said motor enables a movement of the said lenses

In an embodiment of the invention, an optical tracking unit is capable of recording 3D or 2D view of the object by “total interference pattern recording”.

In an embodiment of the invention, an optical tracking unit is capable of identifying and distinguishing between a 3D object and a 2D image of the object.

In an embodiment of the invention, an optical tracking unit is capable of detecting a distance between a lens of optical tracking unit and an object that is been recorded.

In an embodiment of the invention, the system further comprises of a retinal projector which is incorporated with an optical tracking unit or an electronic device.

In an embodiment of the invention, the system further comprises of a suite, wherein a suite is made of a grid formed by films, wherein the films intersect each other at different points and one or more of the film is connected to a photo detector or sensor; wherein a suite is capable of acting as a screen unit.

In an embodiment of the invention, suite is connected to a power source, a light source and a vibrating unit.

In an embodiment of the invention, an optical tracking unit is capable of identifying a recorded object, wherein a recorded object is compared with already existing data and list of matching results are given.

In an embodiment of the invention, an input assembly is incorporated with a gaming devices such as but not limited to Controllers, Light guns, Music and rhythm peripherals, Miscellaneous peripherals, Fishing rod peripherals, Mouse peripherals, Game controllers, Memory units, Satellaview, Aladdin Deck Enhancer, Sega 32X, Sega Mega-CD, Famicom Disk System, Super Game Boy, Microphones, DJ Hero turntables, Rock Band 3 “Pro” controllers, Drum kits, Guitar controllers, Arkanoid Controller, ASCII Stick L5, Bandai Karaoke Studio, Barcode Battler II, Datach, FamiCoin, Famicom 3D System, Famicom Data Recorder, Famicom Controller, Family Converter, Family Computer Disk System, Famicom Fourway Adaptor, Famicom Light Gun, A handgun, Video game light gun, Famicom Modem, Famicom RF Booster, Famicom S.D. System, Family BASIC Keyboard, the Family BASIC, Family Robot, Family Trainer, Famicom TVNET, Gun Sight, Head Cleaning Card, Joystick7, Joycard Sanusui SSS, MultiBox, Party Room 21 Controller, Power Glove, Reggie's Joystick, Spica T89, Super Controller, Toyo Stick, Turbo File and Turbo File II, Wu Ho Cassette Adaptor, Acclaim Remote Controller, NES Advantage, Aladdin Deck Enhancer, Arkanoid Controller, Double Player, Epyx 500XJ, Joystick, Freedom Deck, Freedom-Pad, Game Genie, Game Genie NES101 Adaptor, The Game Handler, Game Key, HFC (Hands Free Controller), Jammer, Joycard Sanusui SSS, LaserScope, NES Lockout, NES Max, Magic Key, Mega Miracle Piano Power Glove, Power Pad, Pro Beam Light Gun, Zapper Light Gun, Quickshot Arcade, Quickshot Aviator 2, Quickshot Trackball, QuickShot, Quickshot Wizmaster, Quickshot sighting scope, R.O.B., Roll 'n Rocker, Satellite, Speedboard, Speedking, Super Chair, Super Controller, Superstick, Teleplay Modem, Turbo Tech Controller, Turbo Touch 360, Turbotronic, UForce, Ultimate Superstick, Zapper Light Gun, Zinger, Zoomer, any similar input or electronic devices, or any combinations thereof.

For the purpose of this invention, the term “total interference pattern recording” means the phenomenon used to record and view 3D image of an object, wherein a transparent screen unit preferably LCD display and an optical arrangement for emitting light rays of similar wave lengths are used, and wherein the light rays are parallel to each other and focus on an object to be recorded. The light rays pass through special lenses to avoid unwanted rays and noise and fall on the object to be recorded. Further, diverging rays are reflected from 3D object (object beam) which falls over the screen. The optical arrangement of LEDs and specially coated lenses is used to produce parallel rays (reference beams). These reference beams makes particular angle with perpendicular drawn to the screen surface which interferes with object beams. Each point on the screen acts as a separate light emitting point. Thus, total interference pattern is formed over a screen.

For the purpose of this invention, the term “sensor” means a sensing component connected to a screen made up of vertical and horizontal grids, wherein sensing component may be photo sensitive.

For the purpose of this invention, the term “secondary outgoing signal” means a signal that is transferred from screen unit to an electronic device after receiving an outgoing signal by the screen unit.

For the purpose of this invention, the term “outgoing signal” and “output signal” can be interchangeably used. The term “outgoing signal” or “output signal” means a signal that is transferred from an input assembly to a screen unit.

In an embodiment of the invention, the systems of the invention may be handheld; or fixed or attached or mounted or connected to a part of a body, wherein the ‘a body’ may refer to a living or a non-living body, or any combination thereof.

In an embodiment of the invention, the graphical user interface of the present invention may include 3 dimensional views or 2 dimensional views or multi-dimensional views, or any combination thereof.

A user is any person, machine or software that uses or accesses one or more of the systems or methods of the present invention. A user includes an automated computer program and a robot.

In an embodiment of the invention, the systems and methods can be practised using any electronic device. An electronic device for the purpose of this invention is selected from any device capable of processing or representing data to a user and providing access to a network or any system similar to the interne, wherein the electronic device may be any suitable electronic medium which is either already in use or may be developed in future such as but not limited, personal computers, mobile phones, laptops, palmtops, portable media players, electronic tablets, smart phones, electronic notebooks, touchpads, communicator, personal digital assistants, or any combinations thereof.

In an embodiment of the invention, the systems and methods of the present invention are used to prevent or restrict hacking or related phenomenon such as but not limited to phishing, man in the middle attack, inside jobs, rogue access points, back door access, use of viruses and worms, use of trojan horses, denial of service attack, sniffing, spoofing, ransomware or any combination thereof.

In an embodiment of the invention, the systems and methods of the present invention provides or enables a user interface which may allow commands for a command line interface or a graphical user interface (GUI) enabling a user to create, modify and delete data or metadata or program or logic or algorithm or parameters associated with encryption method or encryption program or encryption language.

In an embodiment of the invention, the systems and methods can be practised using any electronic device which may be connected to one or more of other electronic device with wires or wirelessly which may use technologies such as but not limited to, Bluetooth, WiFi, Wimax. This will also extend to use of the aforesaid technologies to provide an authentication key or access key or electronic device based unique key or any combination thereof.

In an embodiment of the invention, the systems and methods can be practiced using any electronic device which may contain or may be infected by one or more of an undesirable software such as but not limited to a virus, or a Trojan, or a worm, malware, spyware, adware, scareware, crimeware, rootkit or any combination thereof.

In an embodiment of the invention the system may involve software updates or software extensions or additional software applications.

In an embodiment of the invention, any form of interne security such as but not limited to, a firewall or antivirus or antimalware or registry protection can be used by a user in the same or different electronic device either simultaneously or separately, along with the systems or methods of the present invention.

The described embodiments may be implemented as a system, method, apparatus or article of manufacture using standard programming or engineering techniques related to software, firmware, hardware, or any combination thereof. The described operations may be implemented as code maintained in a “computer readable medium”, where a processor may read and execute the code from the computer readable medium. A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices. An “article of manufacture” comprises computer readable medium, hardware logic, or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

In an embodiment of the invention computer program code for carrying out operations or functions or logic or algorithms for aspects of the present invention may be written in any combination of one or more programming languages which are either already in use or may be developed in future, such as but not limited to Java, Smalltalk, C++, C, FoxPro, Basic, HTML, PHP, SQL, JavaScript, COBOL, Extensible Markup Language (XML), .Pascal, Python, Ruby, Visual Basic .NET, Visual C++, Visual C# .Net, Python, Delphi, VBA, Visual C++ .Net, Visual FoxPro, YAFL, XOTcl, XML, Wirth, Water, Visual DialogScript, VHDL, Verilog, UML, Turing, TRAC, TOM, Tempo, Tcl-Tk, T3X, Squeak, Specification, Snobol, Smalltalk, S-Lang, Sisal, Simula, SGML, SETL, Self, Scripting, Scheme, Sather, SAS, Ruby, RPG, Rigal, Rexx, Regular Expressions, Reflective, REBOL, Prototype-based, Proteus, Prolog, Prograph, Procedural, PowerBuilder, Postscript, POP-11, PL-SQL, Pliant, PL, Pike, Perl, Parallel, Oz, Open Source, Occam, Obliq, Object-Oriented, Objective-C, Objective Caml, Obfuscated, Oberon, Mumps, Multiparadigm, Modula-3, Modula-2, ML, Miva, Miranda, Mercury, MATLAB, Markup, m4, Lua, Logo, Logic-based, Lisp (351), Limbo, Leda, Language-OS Hybrids, Lagoona, LabVIEW, Interpreted, Interface, Intercal, Imperative, IDL, Icl, ICI, HyperCard, HTMLScript, Haskell, Hardware Description, Goedel, Garbage Collected, Functional, Frontier, Fortran, Forth, Euphoria, Erlang, ElastiC, Eiffel, E, Dylan, DOS Batch, Directories, Declarative, Dataflow, Database, D, Curl, C-Sharp, Constraint, Concurrent, Component Pascal, Compiled, Comparison and Review, Cocoa, CobolScript, CLU, Clipper, Clean, Clarion, CHILL, Cecil, Caml, Blue, Bistro, Bigwig, BETA, Befunge, BASIC, Awk, Assembly, ASP, AppleScript, APL, Algol 88, Algol 60, Aleph, ADL, ABEL, ABC, or similar programming languages.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” or “comprising,” when used in this specification, specify the presence of stated features, integers, steps, operations, elements, or components, but do not preclude or rule out the presence or addition of one or more other features, integers, steps, operations, elements, components, or groups thereof.

The process steps, method steps, protocols, algorithms or the like may be described in a sequential order, such processes, methods, protocol and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

In an embodiment of the invention, the component or the parts of the system may be coated, painted or coloured with a suitable chemical to retain or improve its properties, or to improve the aesthetics or appearance.

In an embodiment of the invention, the components of the present invention may be connected or arranged by using any suitable method and may include without limitation use of one or more of welding, adhesives, riveting, fastening devices such as but not limited to screw, nut, bolt, hook, clamp, clip, buckle, nail, pin, ring.

### DETAILED DESCRIPTION OF ACCOMPANYING DIAGRAMS

FIG. 1 is the diagrammatic representation of an example of one of the embodiments of the invention, wherein different screen units are shown. A screen unit shows four different applications 104, 105, 106 and 107 running simultaneously over the screen. A control unit 108 is connected to the screen. The screen made is of horizontal and vertical grids of transparent material like T.I.T.O. films. Projectors 101 and 102 are mounted over the edges of screen unit. Mechanical controller 103 is connected to the projector 102. Set of the areas 109 and 110 show different functional regions over the screen. Long press of these area are responsible for specific activity like moving, duplicating, deleting, downloading the applications. The area 114 is used to download a specific application. 112a are the projection areas, when an application dragged in the projection area, system projects the application on specified screen. The host computer, i.e. electronic device 108b, controls the activity. A screen unit 120 is composed of low throw projectors, wherein a controller 121 has software that synchronizes projector 119 to form single graphic on the screen. The direction of the projector 119 can be changed using the remote controller assembly, to change the direction of the projection. Brighter projector screens 123 projects brighter projections compared to other projectors. Nine projectors combinedly project single graphic over the screen. The number of projectors may vary depending on focus parts of graphics over the screen controller 122 controllers the activity of the screens.

FIG. 2a, FIG. 2b, FIG. 2c, FIG. 2d, FIG. 2e and FIG. 2f are the diagrammatic representations of an example of one of the embodiments of the invention, wherein different projectors are shown. The brighter projector screens used for better quality are illustrated in the figure. The screen unit 201 has low throw projectors for image production. 208 is one of the several low throw projectors which combinedly focus an image. 207 is the triangular area focused by single projector 208. Several such projectors are arranged in array for brighter graphics. 202 shows a screen unit composed of some low throw projectors and some simple projectors, where 212 and 214 are simple laser projectors making a specific angle with screen unit, 215 is combined area of their projection while 211 and 213 are areas covered by one of them. 209 and 210 are low throw projectors closer to screen unit. 203 is the low throw projector screen unit viewed from one side. 221 is low throw projectors focus over screen making an angle 220 typically in the range of 120 and 130 degrees. 222 is a very small distance (e.g. 1.5 mm-2 mm) between projector and screen. 204 front view of the flexible screen unit. 216 is the area covered by projector behind the screen. 205 is a side view of the screen unit, wherein the brighter laser projector 217 making a specific angle. 218 is a distance of projector from screen. 206 is the back view of same screen unit 219 is the square area covered by one laser/simple projector.

FIG. 3a, FIG. 3b, FIG. 3c, FIG. 3d, FIG. 3e, and FIG. 3f are the diagrammatic representations of an example of one of the embodiments of the invention, wherein different input devices which may be connected to an input assembly are shown. These input assemblies are smart wearable actuation devices. 301 is shows wearable actuator of right handed person. 306 show two LEDs (light emitting diodes) these LEDs 307, 308, 309, and 310 are 1st, 2nd, 3rd and 4th touch keys respectively. 311 is a touch scrolling rod plate. Four visible LEDs show battery levels. 303 is the back view of device 301. Provision for elastic bandage for finger is show in diagram 303. 306 and 307 are two wearable actuators for right and left index fingers having small cameras on front side. 304 shows wearable actuator connected to watch 315 having bigger batteries for external charge. 305 shows wearable actuator connected to handheld external batteries 316. 302 is wearable actuator fixed in gun type instrument for gaming purpose. 314 is external battery. 302 is vibration feedback assembly. 313 is wireless signal receiver for any type of feedback.

FIG. 4a and FIG. 4b are the diagrammatic representations of an example of one of the embodiments of the invention, wherein 3D locator and its components are shown. 403 and 404 shows two front cameras separated by specific distance (ideally 24 mm), 409 is the rear camera and 408 is more sensitive circular part of touch pad. 406 and 407 are the position of scrolling rod plates for right or left handed person. 405 is accelerometers, while 402 shows different design of device having only one accelerometer. 410 and 411 are provisions for connections for external charge and headphones.

FIG. 5a, FIG. 5b and FIG. 5c are the diagrammatic representations of an example of one of the embodiments of the invention, wherein different input devices used for gaming purpose, which may be connected to an input assembly are shown. A circular platform (device) 503, has a pressure, light sensor's, and is operated with legs. A head mounted 3D display 502, has an integrated sound system that may be directly fitted over ears of the user. A head mounted 3D display 502, also has 3D locator device over it. An gun type input device 501, has is the detachable actuator 504 fixed to it. A wireless signal receiver 505, external charge battery 506 and vibration feedback system 507 are also fixed in a gun type input device 501.

FIG. 6 is the diagrammatic representation of an example of one of the embodiments of the invention, wherein a working of an input device which may be connected input assembly is shown. the controller 609 controls the activity. 611 is battery and 604 is wireless signaling system which give signals to controlling electronic device of the screen. 602 shows two LEDs and their front lenses. 603 is a front reader camera. 605 is acceleration. 607 shows four touch keys. 608 is a microphone. 612 is a touch sensitive scrolling rod plate made of electrodes. The letter (D) shows a semiconductor diode to detect changes in current and give signals to controller.

FIG. 7 is the diagrammatic representation of an example of one of the embodiments of the invention, wherein a working of a 3D locator which may be connected input assembly is shown; and wherein 711 is the battery, 713 is the controller, 712 is wireless signaling system which give signals to controlling computer of screen and 703 is wireless receiver of signals from controlling unit of an electronic device. 714 and 708 are front and back acceleration sensors shown by letter (A), 702 shows two front cameras separated with specific distance typically of 24 mm for position detection, for 3d imaging and as web camera. 706 shows back camera for position detection with front camera. 710 is sensitive touch pad. 709 show four LEDs for showing battery levels. 707 is touch sensitive scrolling rod plate and 705 shows pressure sensitive keys. 704 is for external connection for external charge and headphones. The letter (D) shows a semiconductor diode to detect changes in current and give signals to controller.

FIG. 8a and FIG. 8b are the diagrammatic representation s of an example of one of the embodiments of the invention, wherein the working of wearable multipointer device and 3D locator device is shown; and wherein 804 and 805 are wearable actuator focusing two diverging beams towards the screen unit and 3D. 801 is the screen having thin transparent semiconductor vertical films rows on a glass or any flexible matrix substrate. These films are flat and transparent having length equal to the height of screen unit and very small width (0.5-1 mm) .these films are connected to a photo-detector at one end. 802 is the screen having thin transparent semiconductor horizontal film rows on a glass or any flexible matrix substrate. 810 is magnified views of the films. 803 shows 1st, 2nd and 3rd layers of screen unit. The first layer 809 is composed of vertical semiconductor film, second layer 808 is composed of horizontal semiconductor film and third layer 807 is the screen showing graphics. 806 is pin junction diode that acts as a photo-detector.

FIG. 9a and FIG. 9b are the diagrammatic representations of an example of one of the embodiments of the invention, wherein applications of the disclosed system is shown. 901 shows the car mounted computer system and screen units, wherein the flexible and transparent screen unit 905 has navigation map over it and 906 is the projector. 903 and 907 are the graphics projected by these projectors over the wind shield of vehicle. 904 shows the area of dotted lines where the transparent semiconductor film is applied in inner side of wind shield. 902 shows the news or book reader. 904 is the low throw projector screen unit. 908 is the transparent semiconductor film for touch input.

FIG. 10a and FIG. 10b are the diagrammatic representations of an example of one of the embodiments of the invention, wherein “total interference pattern recording and viewing” is shown. “Total interference pattern recording and viewing” is one of the applications of the system disclosed. 1016 is a transparent screen unit preferably LCD display. 1003 is an optical arrangement for emitting similar wavelength light beams. These light rays, are parallel to each other and focus an object 1005 to be recorded. The light rays passes through special lenses to avoid unwanted rays and noise. 1004 are parallel rays falling on the object. 1006 are diverging rays reflected from 3D object (object beam) which fall over the screen. 1008 is optical arrangement (LEDs and specially coated lenses) to produce parallel rays (reference beams). These reference beams makes particular angle with perpendicular drawn to the screen surface which interferes with object beams. 1005 is object to be recorded. Each point on the screen acts as a separate light emitting point. 1016 is a LCD screen over which interference is to be recorded. 1009 is optical arrangement for focusing the object. 1010 shows parallel rays focusing virtual object 1011. 1012 is diverging object beams. 1002 is an optical arrangement for focusing reference beam over screen. The reference beam makes a particular angle to a perpendicular drawn to the screen surface.

FIG. 11a, FIG. 11b and FIG. 11c are the diagrammatic representations of an example of one of the embodiments of the invention, wherein an example of “total interference pattern recording and viewing” is shown; and wherein 1101 is the object to be recorded, 1103 is the distance between object and the clear virtual image formed. 1104 is the distance between the camera and the virtual image formed. 1102 is focal length f. Based on the distance between the object and the image of the objects is obtained. The neared object 1110 gives clear image 1114, comparatively distant image 1109 gives blur image 1113 and the distant image 1108 image gives more blurred image 1112.

FIG. 12 is the diagrammatic representation of an example of one of the embodiments of the invention, wherein digital recording cameras for 3D recording of objects is shown are shown. Cameras 1205 record a 3D view of objects 1207 & 1208, 1209 and 1210 with the help of object detection sensor units 1201, 1202, 1203 and 1204 respectively. 1204 is an optical focusing arrangement of digital cameras 1205.

FIG. 13 is the diagrammatic representation of an example of one of the embodiments of the invention, wherein 1301 and 1302 are retinal projector spectacles for displaying advertisements, 1305 is a transaction machine at public place having screens 1308 and 1309. 1306 is a smart phone 1 for controlling transactions of the user account through transaction machine and 1307 is smart phones showing advertisements and transaction details.

FIG. 14 is the diagrammatic representation of an example of one of the embodiments of the invention, wherein one of applications of the system disclosed herein is shown and wherein 1403 and 1404 are retinal projector spectacles, 1401 is the host computer, 1402 is a modem for receiving wireless signals, 1405 and 1406 are smart phone or similar device. 1408 is a laser camera of a gun unit.

Furthermore, this invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout the description of the figures. It will be understood that when an element is referred to as being “connected” or “coupled” to another element, it can be directly connected or coupled to the other element or intervening elements may be present. In contrast, when an element is referred to as being “directly connected or coupled” to another element, there are no intervening elements present. Furthermore, “connected” or “coupled” as used herein may include wirelessly connected or coupled. As used herein, the term “and/or” includes any and all combinations of one or more of the associated listed items.

The aim of this specification is to describe the invention without limiting the invention to any one embodiment or specific collection of features. Person skilled in the relevant art may realize the variations from the specific embodiments that will nonetheless fall within the scope of the invention.

It may be appreciated that various other modifications and changes may be made to the embodiment described without departing from the spirit and scope of the invention.

I claim:

1. A system for enabling or accessing or viewing components through a graphical user interface, wherein the system comprises,
a) an input assembly;
b) a screen unit; and
c) an electronic device;
wherein the said input assembly comprises,
i. a sensory component;
ii. a data processing unit; and
iii. a selection component;
wherein the said screen unit is connected to the said electronic device; and
wherein the said input assembly is capable of throwing an outgoing signal towards the said screen unit in a manner to direct the said outgoing signal on the said screen unit using the said selection component; and
wherein on receiving the said outgoing signal, the said screen unit sends a secondary outgoing signal to the said electronic device; and
wherein the said electronic device processes the said secondary outgoing signal and transfers a final outgoing signal to a graphical user interface enabled by the electronic device to generate a output.

2. The system of claim 1, wherein the said sensory component receives an incoming signal based on a user input and the said processing unit converts the said incoming signal to an outgoing signal which is directed towards the said screen unit using the said selection component, wherein the said selection component enables the said input assembly to select a region on the said screen unit which allows to receive the said outgoing signal, and then the said selection component emits and directs the said outgoing signal on the said selected region on the said screen unit.

3. The system of claim 1, wherein the said screen unit is capable of acting as the said input assembly.

4. The system of claim 1, wherein the said input assembly uses the said sensory component to receive the said incoming signals, processes the said incoming signal through the said processing unit and emits the said outgoing signal through the said selection component; wherein the outgoing signal is received by the said screen unit.

5. The system of claim 1, wherein, the said screen unit comprises a grid formed of films, wherein the said films intersect each other forming a points and at least one of the films is connected to a sensor.

6. The system of claim 1, wherein the said sensor is capable of recording the distance between the said input assembly and the said screen unit.

7. The system of claim 1, wherein the said films are made up of a material which is selected from a group of transparent, semi-transparent, translucent, semi-translucent, opaque, non-conductors, conductors, semi-conductors and any combination thereof.

8. The system of claim 1, wherein the said signal emitted by the said input assembly is received by the film which is detected by the said sensor connected to at least one of the films.

9. The system of claim 1, wherein the said input assembly comprise a remote sensory component which is used for direct human interaction with the system selected from a group of through human gestures, signs, motion, signal, a particular human activity, and any combination thereof.

10. The system of claim 1, wherein the said input assembly allows a user to perform functions selected from a group of accessing data stored in an electronic device, to select one or more virtual object, to highlight or select one or more part visible on the screen, and any combination thereof.

11. The system of claim 1, wherein the system further comprises of a three dimensional optical unit and a projector unit wherein the three dimensional optical unit and the projector unit is connected to a screen.

12. A method for enabling or accessing or viewing components through a graphical user interface comprises steps of,
a) sensing of a user input by a sensory component in the form of an input signal;
b) processing of the input signal by a data processing unit into an outgoing signal;
c) transforming the voice, or touch, or gesture, or movement into the said input signal;
d) using a selection component to emit and direct the outgoing signal on the selected region on the screen unit;
e) receiving the outgoing signal emitted from the input assembly by the screen unit;
f) transferring a secondary outgoing signal by the screen unit to an electronic device;
g) using a data processing unit of the electronic device connected to the screen unit to the process the said secondary outgoing signal; and
h) using a final outgoing signal generated by the electronic device data processing unit to provide a graphical user interface output through a graphical user interface enabled by the electronic device.

13. A system for enabling or accessing or viewing components through a graphical user interface, wherein the system comprises,
a) an input assembly;
b) a screen unit; and
c) an electronic device;
d) a three dimensional optical unit and
e) a projector unit;
wherein the said input assembly comprises,
i. a sensory component;
ii. a data processing unit; and
iii. a selection component; and
wherein the said screen unit to the said electronic device; and
wherein the said input assembly is capable of throwing an outgoing signal towards the said screen unit in a manner to direct the said outgoing signal on the said screen unit using the said selection component; and
wherein on receiving the said outgoing signal, the said screen unit sends a secondary outgoing signal to the said electronic device; and
wherein the said electronic device processes the said secondary outgoing signal and transfers a final outgoing signal to a graphical user interface enabled by the electronic device to generate a output; and
wherein the three dimensional optical unit is connected to the said screen and the said projector unit is connected to the said electronic device; and
wherein the said three dimensional optical unit comprises,
A. at least one detector and
B. at least one optical tracking unit; and
wherein the said at least one optical tracking unit is connected to the at least one detector unit;
and wherein the said optical tracking unit comprises at least one motor and a set of lenses; and
wherein the said motor enables a movement of the said lenses.

14. The system of claim 13, wherein the said optical tracking unit is capable of recording 3D or 2D view of the object by a process of “total interference pattern recording”.

15. The system of claim 13, wherein the said optical tracking unit is capable of identifying and distinguishing between a 3D object and a 2D image of the object.

16. The system of claim 13, wherein the said optical tracking unit is capable of detecting a distance between the said lens of optical tracking unit and an object that is been recorded.

17. The system of claim 13, wherein the system further comprises of a retinal projector which is incorporated with the said optical tracking unit or the said electronic device.

18. The system of claim 13, wherein the system further comprises of a suite, wherein a suite is made of a grid formed by films, wherein the films intersect each other at different points and one or more of the said film is connected to a photo detector or sensor; wherein the said suite is capable of acting as the said screen unit.

19. The system of claim 13, wherein the said suite is connected to a power source, a light source and a vibrating unit.

20. The system of claim 13, wherein the said optical tracking unit is capable of identifying the recorded object, wherein the said recorded object is compared with an already existing data and list of matching results are given.
